(19) United States
(12) Patent Application Publication
(10) Pub. No.: US 2013/0110902 A1
(43) Pub. Date: May 2, 2013

(54) SYSTEM FOR PROCESSING DATA RELATING TO BUILDINGS

(71) Applicants: Jean-Roch Houllier, Saint-Michel Sur Orge (FR); Mounir Soudani, Nozay (FR)

(72) Inventors: Jean-Roch Houllier, Saint-Michel Sur Orge (FR); Mounir Soudani, Nozay (FR)

(21) Appl. No.: 13/695,848

(22) PCT Filed: May 2, 2011
(86) PCT No.: PCT/EP2011/056903

§ 371 Date: Nov. 28, 2012

(30) Foreign Application Priority Data
May 17, 2010 (EP) 10163022.6

(51) Int. Cl. H04L 29/08

(52) U.S. Cl. CPC H04L 67/02
USPC 709/201

(57) ABSTRACT

The present invention relates to a system (100) for processing data related to buildings (106, 108), which system (100) is implemented so as to allow a user (102) to access, from a mobile terminal (104), particularly one located near a first building (106), data related to second buildings (108) selected so as to feature technical properties similar to the technical properties of said first building (106), characterized in that it comprises:
means (122, 1241. 1261, 1281, 1242. 1262, 1282, 1243. 1263, 1283) for automatically identifying, particularly via a telecommunication network (112) such as the Internet, data related to geographic locations and/or construction periods of said first building (106) and said second buildings (108),
means for defining a maximum geographic distance (Rmax) between buildings and a maximum temporal distance between construction periods of said buildings,
means (114, 116, 118, 120, 122) for automatically selecting and displaying data related to said first building (106) and to said second buildings (108) whenever those second buildings are located a distance away from said first building less than the maximum geographic distance (Rmax) and constructed during a period distant from the first building's construction period by a temporal distance less than the maximum temporal distance (Tmax).

This invention relates to a system for processing data related to buildings.

Many professionals in different trades carry out studies of buildings for projects related to, for example, the construction of new buildings or the renovation of existing buildings.

For this reason, such a professional must generally travel into the field, meaning to the location of the building to be constructed and/or renovated, in order to collect information relevant to his or her project, such as the nature of the ground or the environment of the building in question.

Among the relevant information, the professional generally wants to obtain information related to buildings technically similar to the building to be constructed or renovated, because studying changes in those similar buildings may make it possible to emphasize which improvements should be taken into account when erecting/renovating the building in question.

In fact, buildings constructed using identical processes generally have similar advantages and defects that appear over time.

Nonetheless, as indicated above, a professional naturally needs to travel into the field in order to identify which parameters will be relevant in searching for similar buildings. In the field, however, a professional does not have the documents—archives and encyclopedias—whose purpose is to list buildings by their technical features.

This invention aims to remedy this drawback by providing a system that allows a building professional to have access, at the site of a first building, to information related to buildings with similar features. It derives from the observation that buildings have more similar technical features when they are located less far apart and were manufactured on closer dates.

For example, buildings located near one another generally employ the same construction materials, and buildings constructed in the same era employ the same technical knowledge of the era.

This is why the invention relates to a building-related data processing system. This system is implemented in order to allow a user to access data from a mobile terminal (particularly one located near a first building) that is related to second buildings selected in order to feature technical properties similar to the technical properties of said first building, characterized in that it comprises:
means for automatically identifying, particularly via a telecommunication network such as the Internet, data related to geographic locations and construction periods of said first building and said second buildings,
means for defining a maximum geographic distance between buildings and a maximum temporal distance between construction periods of said buildings,
means for automatically selecting and displaying data related to said first building and to said second buildings whenever those second buildings are located a distance away from said first building less than the maximum geographic distance and constructed during a period distant from the first building's construction period by a temporal distance less than the maximum temporal distance.

Owing to such a system, a professional can, from the site of a first building, access with speed and relevance a list of second building(s) that may feature technical properties similar or identical to the first building.

This way, the person skilled in the art of buildings may determine, in the field, the relevance of implemented properties in order to identify similar buildings, and, once those properties have been identified, use information about the similar buildings to improve his or her building construction and/or renovation project.

In one embodiment, the system comprises means for displaying said first building and said second buildings by means of an icon located on a screen of the mobile terminal such that the distance between the first building's icon and each icon of a given second building is representative of the geographic distance and/or temporal distance between said first building and said given second building.

According to one embodiment, the system comprises means so that the second buildings' icons are associated with the first building's icon by means of segments, specific to each second building, whose shape, color, and/or any other property is representative of the geographic distance and/or temporal distance between said first building and each second building.

In one embodiment, the system comprises means for identifying third buildings, located at geographic and/or temporal distances away from said first building that are greater than the geographic and/or temporal distances separating said second buildings from the first building, and means for automatically representing said third buildings by icons located on the periphery of the second icons on the screen of said mobile terminal.

According to one embodiment, the system comprises means for displaying the icons of buildings by groups of buildings featuring similar properties of their own.

In one embodiment, the system comprises means so that the properties taken into account comprise at least one of the following properties: a construction period, a construction technique, a construction style, a location, a building function, the name of an architect, and the name of a person who financed the construction.

According to one embodiment, the system comprises means for representing icons of the first building and second buildings along a single axis representative of the geographic and/or temporal distances between said first and second buildings.

According to one embodiment, the system comprises means for switching between a display along an axis representative of the geographic distances and a display along an axis representative of the temporal distances.

In one embodiment, the system comprises means for manually or automatically identifying, by means of satellite coordinates of the GPS (Global Positioning) type, said first building.

The invention also relates to a method for processing data related to buildings, which method is implemented so as to allow a user to access, from a mobile terminal, particularly one located near a first building, data related to second buildings selected so as to feature technical properties similar to the technical properties of said first building, characterized in that it implements a system according to one of the following embodiments performing the following steps:
the step of automatically identifying, particularly via a telecommunication network such as the Internet, data related to geographic locations and construction periods of said first building and said second buildings,
the step of defining a maximum geographic distance between buildings and a maximum temporal distance between construction periods of said buildings, and
the step of automatically selecting and displaying data related to said first building and to said second buildings whenever those second buildings are located a distance away from said first building less than the maximum geographic distance and constructed during a period distant from the first building's construction period by a temporal distance less than the maximum temporal distance.

Other characteristics and advantages of the invention will become apparent upon reading the description below, given by way of an illustrative and non-limiting example, with reference to the attached figures in which:

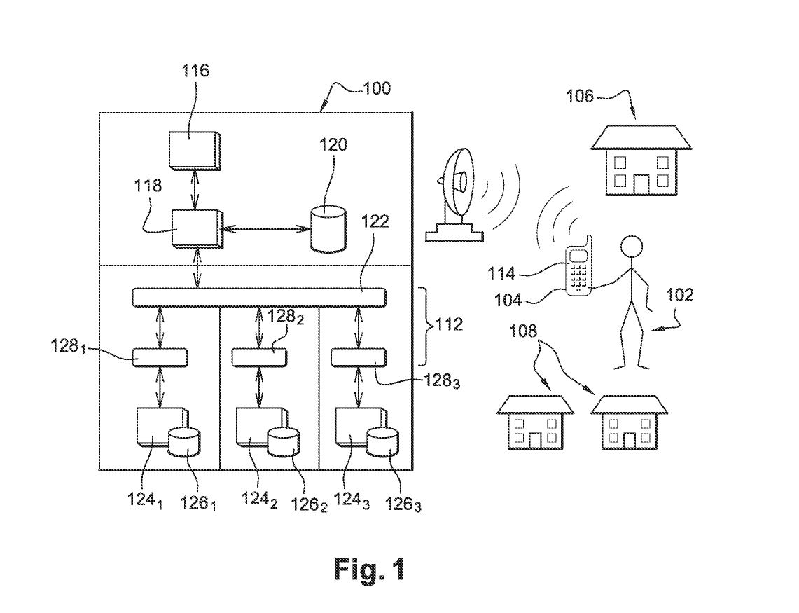

FIG. 1 schematically depicts a system according to the invention,

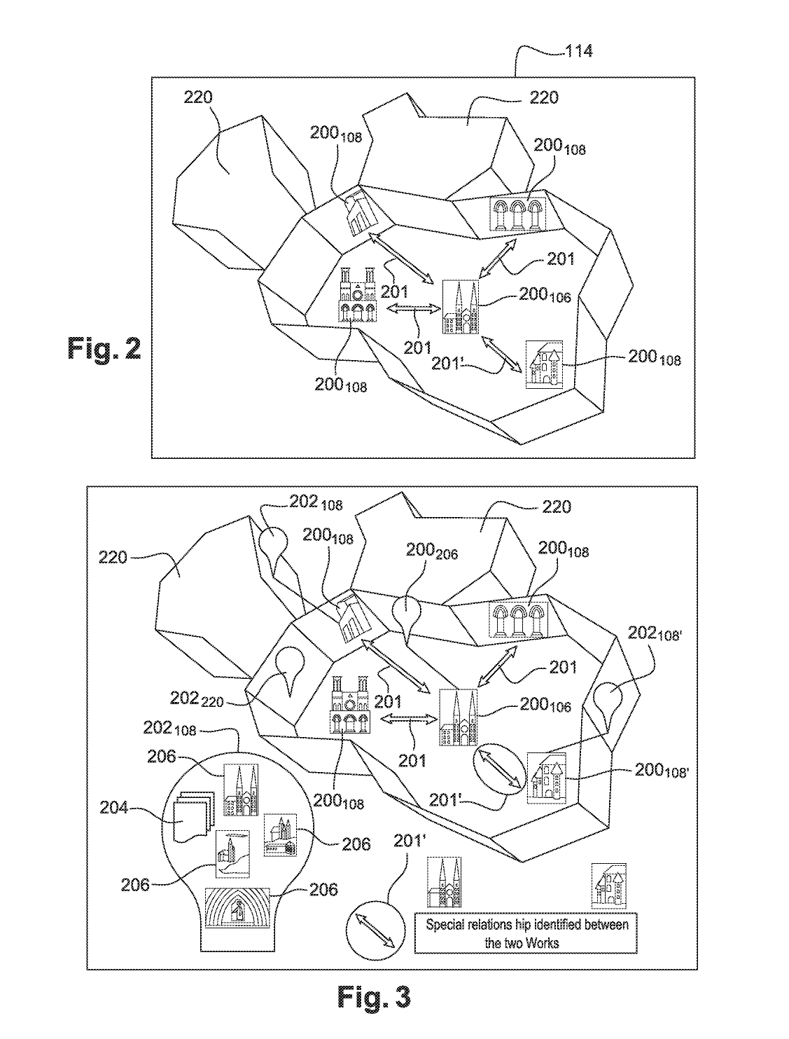

FIGS. 2, 3 and 4 depict human/machine interfaces for the transmit data obtained by a system according to the invention processing temporal and geographic distances between buildings, and

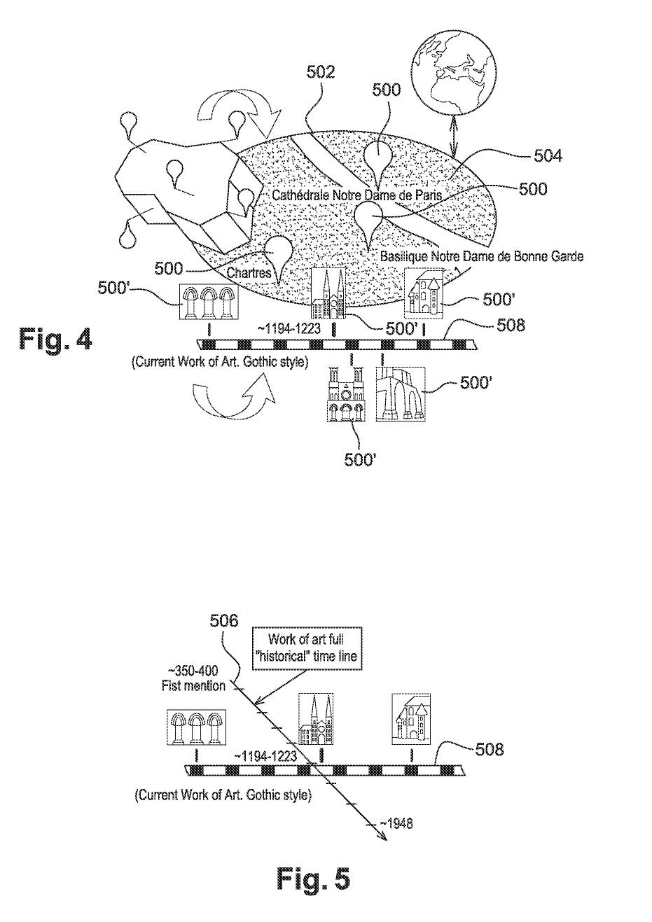

FIG. 4 depicts a human/machine interface transmitting data obtained by a system according to the invention processing different temporal distances.

Identical elements, whether by structure or by function, that appear on different figures have the same references unless otherwise specified.

With reference to FIG. 1, the invention relates to a system 100 for processing building-related data, which system 100 is implemented so as to allow a user 102 to access, from a mobile terminal 104, particularly one located near a first building 106, data related to second buildings 108 selected so as to feature technical properties similar to the technical properties of said first building 106.

To that end, the system 100 comprises means for automatically identifying, particularly via a telecommunication network 112 such as the Internet, data related to geographic locations and construction periods of the first building 106 and second buildings 108.

In this embodiment, those means comprise a software interface 114 or gateway, allowing the user 102 to access said network 112 via a server 116 managed by an operator that offers the terminal 104 access to the network 112.

In order to accelerate access to the data of the network 112, the server 116 is associated with a memory cache 118, as well as a database 120 in which the data obtained via the network 112 is stored temporarily or permanently.

This data related to geographic locations and construction periods of buildings is obtained via software means 122 requesting that data from servers 124₁, 124₂ or 124₃of the network 112.

To that end, those means 122 use a communication protocol, such as the IP (Internet Protocol) protocol assuming that the network 112 is said Internet network, making it possible to transmit such information requests and to receive, via interfaces 128₁, 128₂ or 128₃ compliant with said protocol, data stored by each server 124₁, 124₂ or 124₃ in an associated database 126₁, 126₂ or 126₃.

Furthermore, the user 102 has defined a maximum geographic distance Rmax between buildings (for example 10, 100, 1000 or 10,000 km) and a maximum temporal distance Tmax (for example 10, 50, 100, 200 or 400 years) between building construction periods, so that the means 122 can select, from among the buildings identified in the databases 126₁, 126₂ or 126₃, second buildings 108 located a distance away from said first building less than the maximum geographic distance and built a period distant from the construction period of the first building 106 by a temporal distance less than the maximum temporal distance.

This way, the selected second buildings 108 feature a proximity, in terms of geographic and temporal distance, which makes them likely to feature technical properties similar to the technical properties of the building 106.

At this stage, it should be noted that, depending on the variants, the system hundred comprises means for manually identifying, for example with the help of indications from the user 102 such as entering the name of the building, or automatically, for example by means of satellite coordinates of the GPS (the Global Positioning) type, the location of the first building 106.

Based on the identification of the first building, and in order to make the result of the selection accessible to the user 102, the terminal 104 comprises means for displaying within the interface 114 icons (FIG. 2) of said first building 106 and said second buildings 108 so that the distance between the icon buildings 200₁₀₆ of the first building 106 and each icon 200₁₀₈ of a given second building 108 is representative of the geographic and/or temporal distance between said first building 106 and each second building 108.

Furthermore, in that embodiment, each icon 200₁₀₈ of a second building 108 is associated with the icon 200₁₀₆ of the first building 106 by means of a specific segment 201, meaning one segment specific to each pair formed by the first building 106 and that second building 108.

Typically the shape—in this example, the length—and/or the color of each segment 201 is thereby representative of the distance—geographic and/or temporal—between the first building 106 and the second building 108 associated with said segment 201.

In one variant of the interface 114 depicted in FIG. 3, the icon 200ᵢ of a building i may be associated with an interactive link 202i providing information about the building i in question such as a script 204, for text information, or photographs and images 206 that complement the image used in the icon 200i.

In another variant, a segment 201′ may be highlighted in order to emphasize the existence of a special relationship between the building 106 and the building 108′ associated with that segment 201′.

The icons 200₁₀₈ form a central group, or room, around the icon 200₁₀₆ that is distinct from rooms 220 located at the periphery of that central group and that give access to icons of other buildings that feature fewer similarities, in terms of geographic and temporal distance, with the first building 106.

In one variant of the invention, the system also comprises means for identifying third buildings, located at distances away from said first building 106 that are greater than the distances that separate the second buildings 108 from the first building and/or built on dates distant from the construction date of said first building by a period greater than the second periods of the second buildings.

In such a case, those third buildings may be represented by icons located at the periphery of second icons on the screen of said mobile terminal—which for clarity's sake is not shown in the attached figures.

For clarity's sake, in one embodiment, the icons are displayed by groups of buildings that feature similar properties of their own; such properties may comprise at least one of the following properties: a construction period, a construction technique, a construction style, a location, a building function, an architect's name, and the name of a person who financed the construction of the building.

With reference to FIG. 4, the system 100, or more simply the terminal 114, may comprise means for depicting simplified icons 500 of the first building 106 and second buildings 108 according to a solely geographic representation 502—for example on a map 504—and/or to depict illustrative icons 500′ according to a solely temporal representation 506—for example along a chronological axis 506.

In one embodiment, the system 100 comprises means for simultaneously displaying those two representations and/or means for representing only one of those representations while switching between them.

Furthermore, with reference to FIG. 5, each of those representations may have variants. For example, the representation of the icons 500′ along the first chronological access 506 indicating the period when each building was constructed may be complemented by a second chronological axis 508 indicating additional information such as publication dates related to one or more of those buildings.

The present invention is subject to many variants. For example, the system 100 may be implemented to process data related to technical elements other than buildings for which it may be advantageous to conduct a relevant search based on time and space criteria around a given location.

According to one variant, the invention may be implemented to provide relevant information within the context of cultural projects, such as visiting a building that serves as a museum.

In this context, the invention makes it possible to check from a terminal whether there are any other buildings from a similar era, within a given vicinity and, for example, with a similar style.

More generally speaking, the invention may be implemented in order to obtain information related to works, such as paintings or sculptures, using a method analogous to the method described in this document for buildings. In this way, a user who visit the museum can access, from his or her mobile phone, a virtual museum that shows distant works, and information related to those works, that are related to a visited work (typically similarities such as style, era, location and/or creator).

In such a case, the servers of museums, cultural foundations, and other organizations that may provide information about the technical properties of visited works are implemented as the server 124₁, 124₂ or 124₃. Thus, the visitor/observer of a cultural work can access, via his or her terminal, a great deal of information about works that are important for the visited/observe work automatically, with the results being specified in such a way as to provide technical information (distance, age, etc.) in a simple, appealing way.

Furthermore, the visitor can thereby access all information intrinsic to the works (construction date, style, architect, etc.) and extrinsic to them, i.e. related to other works and to the context in which the work in question was created, which the system can identify on a network such as the Internet.

As a result, the technical properties used to define a building may vary based on the applications of the invention, it being understood that they comprise at least one of the following properties: a construction period, the construction technique, a construction style, a location, a building function, the name of an architect, the name of a patron.

It should be noted that the system according to the invention provides real-time, dynamic information, meaning that it may change based on the parameters—technical properties, maximum distances, etc.—set by its user, which enables him or her to have a database customized to his or her own interests and to the visited building.

Furthermore, the representations of the interface 114 may be two- or three-dimensional (2D or 3D), which allows the system's user to have an intuitive approach with respect to results that are grouped, for example, by construction period or style criteria.

It is possible for a building to be constructed based on different technical properties that are apparently contradictory such of different styles—Roman and Gothic.

In such a case, the building may be associated with all of those different technical properties, or more simply, with only one of them, such as the most recent one (the most recent style) or the most dominant one (main construction material).

1. A system for processing data related to buildings, which system is implemented so as to allow a user to access, from a mobile terminal, particularly one located near a first building, data related to second buildings selected so as to feature technical properties similar to the technical properties of said first building (106), said system comprising:
means for automatically identifying, particularly via a telecommunication network such as the Internet, data related to geographic locations and/or construction periods of said first building and said second buildings,
means for defining a maximum geographic distance between buildings and a maximum temporal distance between construction periods of said buildings,
means for automatically selecting and displaying data related to said first building and to said second buildings whenever those second buildings are located a distance away from said first building less than the maximum geographic distance and constructed during a period distant from the first building's construction period by a temporal distance less than the maximum temporal distance.

2. The system of claim 1 further comprising:
means for displaying icons of said first building and said second buildings that were automatically selected on a screen of the mobile terminal such that the distance between the icon of the first building and each icon of a given second building is representative of the geographic distance and/or temporal distance between said first building and said given second building.

3. The system of claim 2 wherein the icons of the second buildings are associated with the icon of the first building by way of segments, specific to each second building, whose shape, color, and/or other property is representative of the geographic and/or temporal distance between said first building each second building.

4. The system of claim 1, further comprising:
means for identifying third buildings, located geographic and/or temporal distances away from said first building that are greater than the geographic and/or temporal distances away from said first building that are greater than the geographic and/or temporal distances separating said second buildings from the first building, and means for automatically representing said third buildings by icons located on the periphery of the second icons on the screen of said mobile terminal.

5. The system of claim 1 further comprising:
means for collecting the buildings' icons into groups (220) of buildings that feature similar properties.

6. The system of claim 5 wherein the properties taken into account comprise at least one of the following properties: a construction period, a construction technique, a construction style, a location, a building function, the name of an architect, and the name of a person who financed the construction of a building.

7. The system of claim 1 further comprising:
means for representing icons of the first building and second buildings along a single axis representative of the geographic and/or temporal differences between said first and second buildings.

8. The system of claim 7 further comprising:
means for switching between a display on a map representative of geographic distances and a display along an axis representative of the temporal construction distances.

9. The system of claim 1 further comprising:
means for manually or automatically identifying, by means of satellite coordinates of the GPS (the Global Positioning) type, said first building.

10. A method for processing data related to buildings to allow a user to access, from a mobile terminal, particularly one located near a first building, data related to second buildings selected so as to feature technical properties similar to the technical properties of said first building, said method comprising the steps of:
automatically identifying, particularly via a telecommunication network such as the Internet, data related to geographic locations and construction periods of said first building and said second buildings,
defining a maximum geographic distance between buildings and a maximum temporal distance between construction periods of said buildings,
automatically selecting and display distances related to said first building and to said second buildings whenever those distances are located a distance away from said first building less than the maximum geographic distance and built a period distant from the construction period of the first building by a temporal distance less than the maximum temporal distance.
